(19) United States
(12) Patent Application Publication
(10) Pub. No.: US 2012/0306846 A1
(43) Pub. Date: Dec. 6, 2012

(54) Media system and a method for displaying information

(76) Inventor: Sanjay Jadhav Patil, Villa Hills, KY (US)

(21) Appl. No.: 13/134,298

(22) Filed: Jun. 3, 2011

(51) Int. Cl. G06F 17/00

(52) U.S. Cl. 345/418

(57) ABSTRACT

A system 10 which receives content and which displays and communicates the content to an individual 100 according to certain rules.

### FIELD OF THE INVENTION

The present invention generally relates to a media system and to a method for displaying information and more particularly, to a system and a method which, in one non-limiting embodiment, provides targeted medical information to a patient in a profitable manner and in a highly informative manner.

### BACKGROUND OF THE INVENTION

Advertisement and other information (as used in this description, the term “information” is meant to refer to advertisement and to any other types of information or data), of varying types, have greatly proliferated and are communicated, in what often seems to be an unceasing manner, to society. Unfortunately, there has been very little attempt to segregate all of this information by respective groups of people to whom such segregated information respective pertains. For example, weight loss information is probably not going to be really pertinent to an individual suffering from anorexia. Thus, all of us get deluged by information, most of which is not respectively pertinent or interesting, thereby resulting in people “shutting out” or not listening to or responding to any of it. Moreover, in the medical context, such segregation would be especially important since the information is of high value (e.g., the information impacts human life).

There is therefore a need and it is a non-limiting object and aspect of the various present inventions to provide a method and a system to provide targeted medical information (and other information) to people to whom such information is respectively pertinent, and to overcome the various disadvantages of prior systems and strategies.

### SUMMARY OF THE INVENTIONS

It is a first non-limiting object of the present inventions to provide a method and a system to provide targeted medical information (and other information) to people to whom such information is respectively pertinent.

It is a second non-limiting object of the present invention to provide a method and a system to collect a pool of information from a variety of sources and then to determine what information is to be displayed to a patient by use of at least one attribute of that patient.

It is a third non-limiting object of the present invention to provide a method and a system to collect a pool of information from a variety of sources and then to have the sources provide monetary bids which determine a playback priority of such information.

According to a first non-limiting aspect of the present inventions, a media system, such as a medical media system, is provided and includes a display portion; and a processor assembly which receives individual information (such as patient attribute information) and which, by use of the selected individual information, communicates certain information to the display portion, effective to cause the display portion to display the communicated certain information to the targeted individual.

According to a second non-limiting aspect of the present inventions, a medical media system is provided and includes a display portion; and a processor portion which is coupled to the display portion and which receives first media information from a first source and second media information from a second source, which stores the received first and second media information, which receives play bids from the first and second sources, which receives patient information and which uses the received play bids and the received patient information to determine which of the first and second media information to communicate to the display portion.

According to a third non-limiting aspect of the present inventions, a method for displaying medical information is provided and includes the steps of collecting a pool of medical information; determining when a patient is within a certain area; determining at least one medical attribute associated with the patient; selecting a certain portion of the pool of the medical information based upon the determined at least one medical attribute; and displaying the certain portion of the pool of the medical information to the patient.

These and other features, aspects, and advantages of the various present inventions will become apparent from a reading of the following detailed description of the preferred embodiment of the inventions, including the subjoined claims, and by reference to the following drawings.

### BRIEF DESCRIPTION OF THE DRAWINGS

FIG. 1 is a block diagram of a media system which is made in accordance with the teachings of the preferred embodiment of the various inventions.

FIG. 2 is a schematic diagram of the system processor assembly which is shown in FIG. 1.

FIG. 3 is a schematic process diagram illustrating the various processes occurring within the processor which is shown in FIG. 2.

FIG. 4 is a bidding template which is used by the system which is shown in FIG. 1.

### DETAILED DESCRIPTION OF THE PREFERRED EMBODIMENT OF THE INVENTIONS

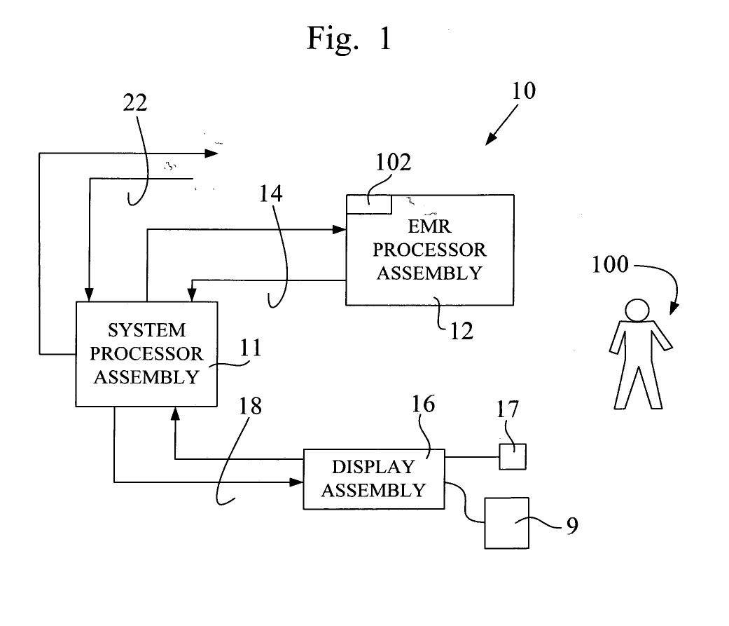

Referring now to FIG. 1, there is shown a targeted media information system 10 which is made in accordance with the teachings of the preferred embodiment of the invention. Particularly, the system 10 includes a processor assembly 11 which is adapted, in one non-limiting embodiment, to communicate with and be coupled to an electronic medical records assembly 12, by the use of bi-directional bus arrangement 14. One non-limiting example of such an assembly 12 is produced by The Sage Corporation and is referred to as “Sage Intergy”, a software product called and “Primesuite 2011” which is produced by The Greenway Corporation. One other non-limiting example is the “EPIC System” made by the EPIC Corporation of Herona, Wis. The system 10 further includes a display assembly 16 (such as a monitor which presents visual information and sounds) which is communicatively coupled to the processor assembly 11 by the use of bi-directional bus arrangement 18. Particularly, the bus arrangement 18 allows information to be communicated to the display assembly 16 where it is displayed and/or otherwise presented and which further allows information to be transmitted from the display assembly 16 to the processor assembly 11. That is, the display assembly may have a keyboard 17 or a touch screen 19 which patient 100 may use to communicate with processor assembly 11. The processor assembly 11 may be further communicatively coupled to a global communications network 22, such as that which is commonly referred to as “The Internet” and such a network 22 allows information to be exchanged between processor assembly 11 and other networks and entities. It should be appreciated that assembly 12 includes the identity of various patients together with associated and respective medical patient data, such as the diagnosed “conditions” of the respective patients, sex, health, weight, age, allergies, respective laboratory test results and respective ordered tests. It should further be appreciated that in other non-medical applications, assembly 12 may be replaced by any other system, assembly, or strategy which provides attribute information about at least one individual. Examples of such attribute information include, butane not limited to age, gender, electronic mail address, and product purchases profile.

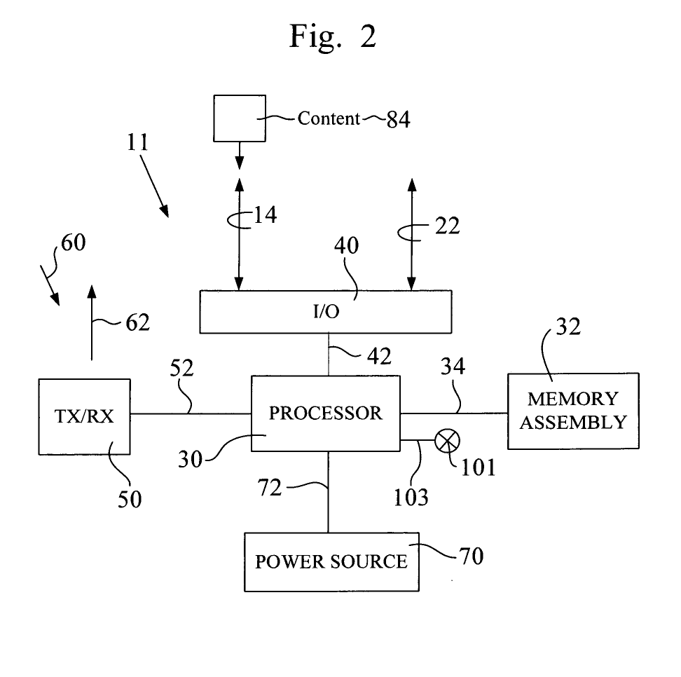

Referring now to FIG. 2, there is shown processor assembly 11 and which includes a processor 30 which is operable under stored program control and which, in one non-limiting embodiment, may comprise a commercially available 14″ processor which is available from the Intel® Corporation. Nothing in this description is meant to limit the processor 30 to any particular type of processor and, in fact, substantially any type of commercially available processor may be employed. The assembly 11 further includes a memory assembly 32 which is coupled to the processor 30 by the bus 34 and which stores the code which defines the operation of the assembly 11 and which further stores information which the processor 30 communicates to the memory 32. The stored information, residing within memory assembly 32, may be selectively read by processor 30, by the use bus 34.

The assembly 11 further includes an input/output portion or assembly 40 which is coupled to the processor 30 by the bus 42 and which is coupled to network 22 and bus assembly 14. The input/output portion 40 receives and temporarily buffers information which is received from entities and networks and which is directed to the processor 30 and then communicates this buffered information to the processor 30 by use of the bus 42. The input/output portion 40 also receives and temporarily buffers information which is received from the processor 30 and then communicates the temporarily buffered information to the entity designated by the processor 30. The assembly 11 also includes a transmitter/receiver assembly 50 which is coupled to the processor 30 by the bus 52 and which is adapted to receive a modulated type of signal (e.g., a radio frequency signal 60) and then demodulates the signal 60 before communicating the information contained in the signal 60 to the processor 30 by the use of bus 52. Similarly, the assembly 50 may receive information from the processor 30, by the use of bus 52, and then modulates the received information, thereby producing signal 62 (e.g., a radio frequency type signal) which is communicated to a targeted entity designated by the processor 30). In this manner, radio frequency type of communication may occur between the assembly 11 and other entities or networks.

The assembly 11 further includes a source of electrical power 70 which is coupled to the processor 30 by the bus 72 and which provides operative power to the processor 30. The processor 30 may supply some of the received power to the memory assembly 32 and to the assembly 52 and to the assembly 40. In one non-limiting embodiment the source 70 comprises a battery. As will be seen below, the processor 30 receives content and allows selected content to be displayed onto display 16 depending upon the characteristics associated with patient 100 who is in close proximity to the display 100 and depending upon certain rules, which are later explained.

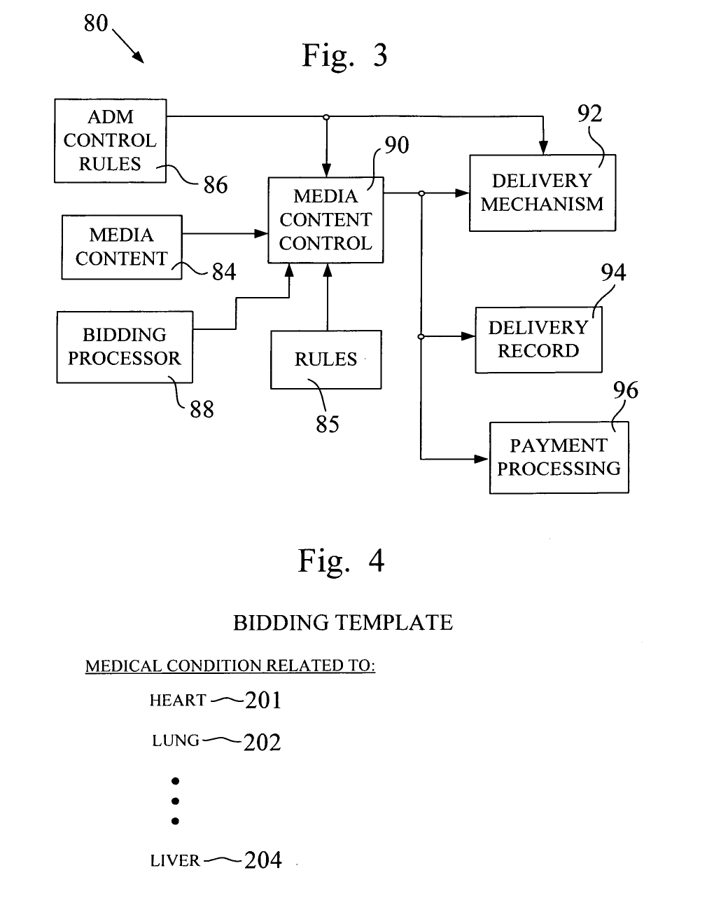

Referring now to FIG. 3, there is shown a processing system chart 80 which will allow the reader to understand the operation of the processor 30 and of the entire system 10.

First, media content 84 in the form of streaming text and/or video is received by the processor 30 and temporarily stored in the memory assembly 32. Such content 84 may be embedded within and/or may form a signal which is placed on the bus 22 and communicated to the processor 30 where it may then be temporarily stored and later selectively retrieved from memory assembly 32. The content 84 may be received from a number of different sources and each sourced content is separately tagged and segregated within the memory assembly 32. Importantly, each of the received content includes pictures, text, and/or sound which is respectively targeted to a specific type of patient (i.e. respective patients having respective medical conditions). One of the principal objects of this invention is to have the processor assembly 10 receive the content, “know” or discern who that respective content is to be given or “targeted” to (the term “given to” means, in this context, displayed on the display assembly 16), determine when a patient is in close proximity to the display assembly 16 and what content is relevant to that patient, and then ensure that patient only receives relevant content. In this manner, the system 10 provides “targeted information” to the patient 100; that is only information which is relevant to that patient's actual medical condition is shown to that patient. Non-limiting examples of such content include, but are not limited to, the effect of a certain drug on a high or elevated cholesterol condition and a coupon providing monetary benefits if a prescription is “filled” at a certain pharmacy. Nothing in this description is meant to limit the content 84 to any particular type of content.

A set of “content playing” rules 85 reside within the memory assembly 32. In the most preferred, although non-limiting embodiment of the various inventions, each content 84, which is generated by a third party, has at least one respective rule which defines the characteristics of the targeted audience. That is, each content 84 has a target rule which defines the medical characteristics of the people who the content originator wants to view that specific content. Non-limiting examples of such rules are the sex to be male, the age to be over 50, the LDL cholesterol to be over 200, and the patient to have diagnosed diabetes. Hence, for each content, a respective rule defines the type of patient which the creator of that respective content has determined is the respective “targeted audience”.

A second set of rules 86 (e.g., administrative rules) also resides within the memory assembly 32 and these administrative rules override any and all of the rules 85. Of course, the rules 85, 86 may initially be communicated to the processor 30 by the bus assembly 22 and temporarily stored and later selectively read from the memory assembly 32. Non-limiting examples of such administrative rules 85 include but are not limited to preventing the “playing” of any content related to contraception or abortion. Primarily, these administrative rules 85 ensures that the health care facility who tends to the various patients have complete control over the type of content which is shown to their patients.

As will be seen further, one non-limiting principal purpose of processor 30 is determine, by use of the rules 85, 86 and input from the assembly 12, which of the content 84 is to be played to a particular patients, such as patients 100. However, it is not enough to just determine what content is to be played to a patient, the order of play is very important. That is, the patient 100 may be targeted for a wide variety of stored content since that patient may meet a number of separate rules 85. For example, the patient 100 may have a number of medical conditions, Thus, in the most preferred, although non-limiting embodiment of the invention, each content provider enters into a bidding process 88. In this bidding process, which is controlled by the processor 30, and which occurs within the processor 30, each content is separately ranked from the highest to the lowest and each content is given a unique rank. A content with a higher rank is played before a content of a lower rank and each content has a respectively unique rank. Each content provider is then given the opportunity to pay extra money to the operator of system 10 in order to have higher ranks for each of their respective content. If two or more content providers desire the same rank, then the providers are subjected to a bidding process in which the individual ranks are auctioned off and such ranks may be valid for a certain time period (e.g., one year) when the auction process begins again. All ranks may, in one non-limiting embodiment, be separately “auctioned off”.

In yet another non-limiting embodiment of the invention, such as shown in FIG. 4, a bidding template 200 which may be utilized. Particularly, the template 200 defines medical conditions separately related to each and every organ of the human body, such as the heart 201, the lungs 202, and the liver 204. Each content 84, if possible, is related to one or more of these organs and separate bidding and rankings occur within each organ (e.g., each organ has a separate content ranking system). Further, non-organ related content (a discount pharmacy coupon) is separately ranked and then a master ranking of each of the organs and a singular non-organ related content is done in order to determine which organ or non-organ category is to be first played, and the content providers within each organ category or non-organ category contribute to the overall category monetary distribution needed to obtain a category ranking. Once a category is chosen, the individual rankings of the content within the chosen category determine the level or order of play or presentation.

Further processes exist within the system 10. For example process 92, which occurs within the processor 30, defines the mechanism which is to be used to deliver the content which is selected by the processor 30 to be “played”. Delivery mechanisms may include, but not be limited to, communication to the display assembly 16 and/or generation of a signal 62 in the form or a cellular telephone type text or sms message. Process 94, occurring within the processor 30, ensures that a record is kept of each and every time each content is “played” and process 96, also occurring within the processor 30, ensures that a bill is generated for each and every play of each of the respective content. The bill is predetermined cost per play of content.

Thus, in operation, when a patient 100 enters a room, such as an examination room, the identification of that patient 100 is entered into the electronic medical records assembly 12 and then that patient's records 102 are made accessible to the processor assembly 11 where they are “read” for certain medical conditions and other pertinent data which is defined by the rules 85, 86. The processor 30 then defines which of the content it to be played to the patient 100 and such content is played upon display until it is stopped when a switch 101, which is coupled to processor 30 by bus 103, is processed by a doctor or medical personnel or after a predetermined time has elapsed.

It should be appreciated that the foregoing inventions may also be applicable to a wide variety of dissimilar industries and applications.

By way of a first example and without limitation, a hair salon typically captures customer related attribute information, such as name address, electronic mail address, cell phone number, and gender. With these captured customer attributes, the processor assembly 30 may have advertising content delivered to the email or cellular telephone of the customer or, in another non-limiting embodiment of the invention, the display assembly 16 may be placed in close proximity to the customer, as that customer is having a haircut or other salon type treatment, and the targeted advertising may then be displayed to the customer upon the display 16.

By way of a second example and without limitation, within an on-line airline ticketing system, there is captured a variety of traveler information such as gender, age, the zip code of that customer's primary residence, and various details of the journey (e.g., destination). With such captured information and knowing the seat number of that customer and plane number, targeted information could be displayed to that customer as that customer is seated in the airplane. Such information could be displayed upon the display which is provided to that customer as part of the in-flight entertainment system (e.g., on the display which is provided to that customer and which is movably attached to the seat that the customer is residing within).

Further, in the medical domain, rules could be created within the processor assembly 30 such that when a specific laboratory result is associated with the patient, then a specific advertisement is presented to that patient. For example, when the ejection fraction of that patient is less than 35%, an advertisement illustrating the risk of heart failure and the need for and advantages of a pacemaker, defibrillator, or other types of devices or treatment are presented. Further, if the processor assembly 30 notes that a certain test is to be accomplished (e.g., a stress test), then a certain video and/or textual information is presented to the patient which explains the test and the advantages and risks associated with the test. The patient may be prompted to touch the screen 19 or enter data from the keyboard 17, thereby acknowledging that such information has been presented to the patient and that the patient gives informed consent of the test. Such acknowledgement type information may then be stored within the memory assembly 32.

Processor assembly 30 may, in yet another non-limiting embodiment of the various inventions, be adapted to place advertisement/educational material on the Facebook® wall of the patients.

It is to be understood that the various inventions are not limited to the exact construction and methodology which has been delineated above, but that various changes and modifications may be made without departing from the spirit and the scope of the inventions as they are further delineated in the following claims. Thus, what has been described is an assembly 10 which may be adapted to provide targeted advertisement/informational content to a wide variety of targeted air devices.

What is claimed is:

1. A media system comprising a display portion; and a processor assembly which receives individual information and which, by use of said received information, communicates certain information to said display portion, effective to cause said display portion to display said communicated certain information to said individual.

2. A medical media system comprising a display portion; and a processor portion which is coupled to said display portion and which receives first media information from a first source and second media information from a second source, which stores said received first and second media information, which receives play bids from said first and second sources, which receives patient information and which uses said received play bids and said received patient information to determine which of said first and second media information to communicate to said display portion.

3. A method for displaying medical information, said method comprising the steps of collecting a pool of medical information; determining when a patient is within a certain area; determining at least one medical attribute associated with said patient; selecting a certain portion of said pool of said medical information based upon said determined at least one medical attribute; and displaying said certain portion of said pool of said medical information to said patient.
